(19) United States
(12) Patent Application Publication
(10) Pub. No.: US 2010/0229214 A1
(43) Pub. Date: Sep. 9, 2010

(54) METHOD AND NODE FOR COMMUNICATIONS ENHANCED WITH TEMPORARY SHARING OF PERSONAL INFORMATION IN A COMMUNICATION NETWORK

(75) Inventors: Zhongwen Zhu, Saint-Laurent (CA); Nazin Hossain, Brossard (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/397,741

(22) Filed: Mar. 4, 2009

(51) Int. Cl. G06F 15/16; G06F 21/00

(52) U.S. Cl. 726/3; 709/229

(57) ABSTRACT

A node and method for temporarily sharing personal information, in a communication network, between at least first and second nodes comprise establishing a communication session, through a session module, between the at least first and second nodes; receiving a permission to access the personal information, through a permission module; and retrieving the personal information upon receiving the access permission, through an information module. Also, prior to establishment of the communication session, the at least first and second nodes have no authorization relationship established therebetween and when the established communication session is terminated, the access permission to the personal information is also terminated.

### TECHNICAL FIELD

The present invention generally relates to communication networks and to sharing of information between different users in the communication networks.

### BACKGROUND

Over the past few decades, Internet has experienced an incredible growth and expansion. Technologies have changed from centralized computing to individualized computing, to mobile computing and now to intelligent services with a convergence of networks, devices and services.

Furthermore, with the introduction of broadband networks, users or customers are expecting more of personalized and interactive multimedia services, combining voice, data, video, etc., on any device and from anywhere. The IMS (IP Multimedia Subsystem) architecture has been developed in this context for meeting the expectations and facilitating multimedia service creation and deployment.

The IMS architecture is specified in 3GPP and was first introduced in UMTS (Universal Mobile Telecommunications System) Release 5 (March 2003). Most of the IMS protocols are standardized by IETF (Internet Engineering Task Force), such as SIP (Session Initiation Protocol) for purposes of ease of integration with Internet. However, the OMA (Open Mobile Alliance) is also involved in the standardization process.

Within the IMS architecture, one of the most popular services has been the presence service, especially for applications such as instant messaging. The presence service allows IMS users to exchange Presence information between each other.

More specifically, an IMS user (called a Presentity) can share his/her Presence information with another user or a service (called a Watcher), once he/she has authorized the watcher to get his/her Presence information. In order to get the Presentity's presence information, the watcher has to subscribe using SIP SUBSCRIBE to the Presentity's Presence Information. If authorized, the Presentity's Presence Service provides the watcher with the Presentity's presence information via SIP NOTIFY. The IMS user's Presence Information can include information about the user, his/her location for example, about his/her services and devices, etc.

Furthermore, using of one OMA's protocols, IMS users can also share their profile information with each other. A user's profile may contain an IMS user's name, his/her address and hobbies, etc.

Based on SIP, multimedia sessions between IMS users can be set up based on a three-way handshake when a caller sends a request to a callee for establishing the multimedia sessions. The three-way handshake consists in three steps: 1) the caller sends the request (SIP INVITE) towards the callee, 2) the callee sends the response (200 OK) back to the caller to confirm his/her acceptance, 3) the caller finally sends the acknowledgement (SIP ACK) to the callee. Such multimedia sessions may include VoIP, multimedia chat, file transfers, etc. However, in order to be able to share and use those services, it is generally preferable for the caller and callee to access each other's presence information and/or profile, thus pre-defined or pre-existing authorizations should be established between the caller and callee.

The current mechanisms for sharing Presence or profile information in an IMS architecture or other internet architectures are generally modelled for applications aiming at building long-term relationships, such as social networking and instant messaging services, through which users are encouraged to communicate with each other on a fairly regular basis over a long period of time.

Sharing of Presence or profile information in other contexts has not been explored yet. Therefore, it would be interesting to provide for more flexible sharing mechanisms of presence and profile information in different contexts.

### SUMMARY

More specifically, in accordance with the present invention, there is provided a method for temporarily sharing personal information, in a communication network, between at least first and second nodes. The method comprises establishing a communication session between the at least first and second nodes; receiving a permission to access the personal information; and retrieving the personal information upon receiving the access permission. Also, prior to establishment of the communication session, the at least first and second nodes have no authorization relationship established therebetween and when the established communication session is terminated, the access permission to the personal information is also terminated.

According to another aspect of the present invention, there is provided a node for temporarily sharing personal information, in a communication network, with at least another node. The node comprises a session module to establish a communication session with the at least another node; a permission module to receive a permission of access to the personal information; and an information module to retrieve the personal information during the established communication session. Also, prior to establishment of the communication session, the node and the at least another node have no authorization relationship established therebetween and when the established communication session is terminated, the access permission to the personal information is also terminated.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic view of an IMS architecture or IMS network for establishing a communication enhanced with temporary sharing of personal information according to a non-restrictive illustrative embodiment of the present invention;

FIG. 2 is a flow chart illustrating a method for communication enhanced with temporary sharing of personal information in the IMS network of FIG. 1;

FIG. 3 is a schematic view of a terminal node for communication enhanced with temporary sharing of personal information in the IMS network of FIG. 1;

FIG. 4 is a flow chart illustrating a detailed method for communication enhanced with temporary sharing of personal information through the terminal node of FIG. 3;

FIG. 5 is a flow chart illustrating a method for terminating the communication session and the temporary sharing of personal information as given by FIG. 4;

FIG. 6 is a schematic view of a communication network for communication enhanced with temporary sharing of personal information according to another non-restrictive illustrative embodiment of the present invention;

FIG. 7 is a flow chart illustrating a method for communication enhanced with temporary sharing of personal information in the communication network of FIG. 6; and

FIG. 8 is a schematic view of a communication enhanced with temporary personal information sharing service used in the communication network of FIG. 6.

### DETAILED DESCRIPTION

Since current mechanisms for sharing presence and profile information are mostly directed to applications for developing long-term relationships between different users, an end user has no easy ways for sharing his/her presence or profile information with another end user, in a temporary manner, for a specific purpose or duration, for example, without requiring the end users to first have any kind of relationships established prior to their sharing session.

Generally stated, non-restrictive illustrative embodiments of the present invention allow end users to share temporarily their presence information or profile information with different end users for a limited period of time, such as during a communication session, the different end users having no need of establishing pre-existing authorization relationships with each other.

The communication session can be a conference session, in which additional end users or services can join.

The illustrative embodiments according to the present invention can be realized in the end user's side (terminal-based) or within the network (network-based) as will be described hereinbelow.

Before going further into the description, it should be noted that in the following description, the term “personal information” will comprise any information that can be shared between different end users based on predefined authorization policies, set by the end users, for example. This means that when an end user wishes to share such information with another end user, modification to the authorization policies of the information needs to be first performed so as to allow the other end user to obtain the information afterwards. The personal information may include presence information and profile information, such as location information, addresses, hobbies, etc.

In the following, the illustrative embodiments according to the present invention will be described in the context of the IMS architecture, therefore in this case the personal information can be also referred to as IMS enabling information. However, these embodiments are not restricted only to such an architecture and may be applied to other communication architectures and networks.

More specifically, in the context of the IMS architecture, the illustrative embodiments of the present invention allow end users to exchange or share their presence or profile information in an ad-hoc fashion concurrent to a conventional SIP communication session or dialog setup procedure. For example, in order to set up a communication session or dialog in an IMS network, a SIP INVITE is sent out by the caller, to which the callee replies back with a SIP 200 OK, then the caller sends a SIP ACK to the callee to acknowledge that the communication session is well established. And in order to obtain presence information from the presentity, the watcher has to subscribe to the presentity's presence information using SIP SUBSCRIBE. Then, through SIP NOTIFY, the watcher is provided with the presentity's presence information.

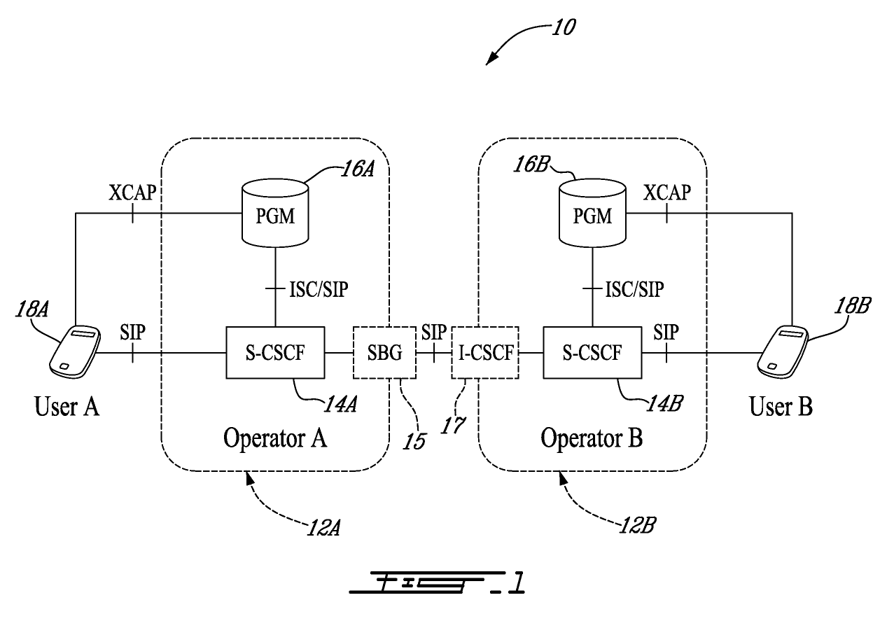

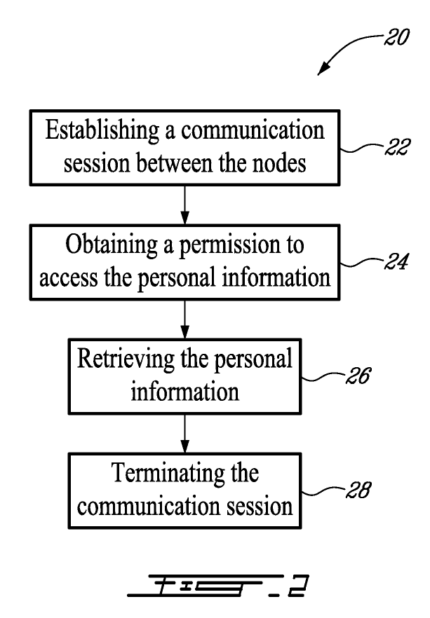

Now turning to FIG. 1, a schematic view of an IMS architecture or IMS network, in which personal information can be shared temporarily between two end users, will be described. Of course, a skilled person in the art would understand that more than two end users can participate in the temporary sharing of personal information.

The IMS network 10 comprises different IMS nodes (not shown) for accomplishing different IMS functionalities, a first communication domain 12A and a second communication domain 12B. The first communication domain 12A can be operated by an operator A and based on the IMS technology. Furthermore, an end user A is connected to the first communication domain 12A using a terminal 18A, which can be any wireless devices or wireline devices having capabilities to communicate with the domain 12A. In the same manner, the second communication domain 12B can be operated by an operator B, based on the IMS technology and an end user B is connected thereto using a terminal 18B.

The IMS based communication domains 12A and 12B respectively have the following nodes: S-CSCF (Serving Call Session Call Function) 14A and 14B and PGM (Presence and Group Management) 16A and 16B.

The S-CSCFs 14A and 14B are signaling nodes for providing routing and session control for example. The S-CSCF 14A and 14B communicate with each other and their respective end users A and B through the SIP protocol.

The PGMs 16A and 16B are presence servers for managing the presence information of end users A and B and for updating presence information and authorization policies of the presence information to which end users A and B are subscribed.

The PGMs 16A and 16B communicate with their respective end users A and B using the XCAP protocol, for example.

The PGMs 16A and 16B communicate with their respective S-CSCF 14A and 14B using the ISC or SIP protocols.

The Session Border Gateway (SBG) 15 of communication domain 12A is a gateway to external networks, such as communication domain 12B. It may comprise a firewall (not shown). In general, SBG 15 hides the topology of the network in which it resides from any external networks.

The SBG 15 uses a SIP interface to connect to other networks through an Interrogating CSCF (I-CSCF) 17 of communication domain 12B. I-CSCF 17 is generally found at the edge of a communication domain. I-CSCF 17 is used to route SIP requests received from communication domain 12A to S-CSCF 14B of communication domain 12B.

It is believed that those nodes are well-known in the art and therefore will not be further described.

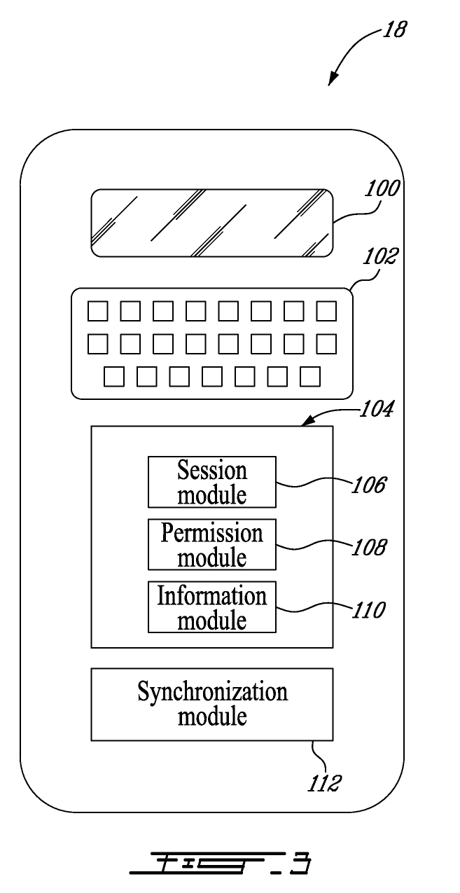

Now, turning to FIG. 2, a method, according to a non-restrictive illustrative embodiment of the present invention, for temporarily sharing personal information will be described, in a communication network, such as the IMS network 10, between at least first and second nodes, such as end users A and B of FIG. 1, without prior authorization relationship established therebetween. Therefore, the method of FIG. 2 provides for a communication enhanced with temporary sharing of personal information.

The method 20 starts with step 22 which establishes a communication session between the first node (end user A) and the second node (end user B). The first node can initiate the request for the communication session or the second node can do it.

In step 24, a permission to access the personal information is obtained or received by the first node and/or the second node.

Upon receiving the access permission, in step 26, the first and/or second nodes retrieve the personal information since they have been authorized to access each other's personal information, the personal information being for example personalized services and presence information.

When the established communication session is terminated either by the first node or the second node, it terminates the access permission to the personal information so that the first and second nodes cannot access each other's personal information any longer. This is illustrated in step 28 of FIG. 2.

Therefore, the sharing of personal information between end users A and B in the IMS network 10 lasts only for the period during which the communication session is established.

### End User's Side (Terminal-Based) Implementation

As a non-restrictive illustrative embodiment of the present invention, method 20 of FIG. 2 can be implemented at the end user's side (terminal-based) in a terminal node of a communication network such as the IMS network 10, in such a manner that this node can offer the service of temporary sharing of personal information between end users.

More specifically, the node can be the terminal 18A, which can be, for example, a mobile phone, a PDA, a laptop, a computer, or any communication device having the capabilities and necessary protocols, such as the SIP, to communicate with the communication network.

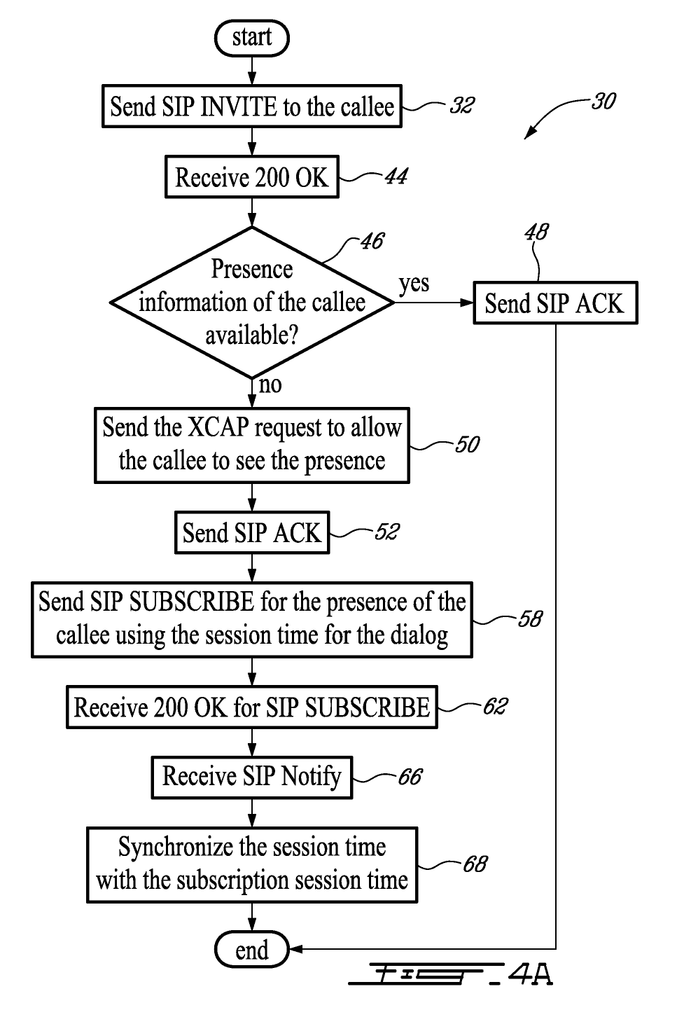

Now turning to FIG. 3, the illustrative embodiment according to the present invention in which the method 20 is implemented at the user-side will be described.

FIG. 3 illustrates a terminal such as 18A, which comprises a screen 100, a keyboard 102, a communication module 104 and a synchronization module 112.

Of course, a person skilled in the art would understand that the terminal 18A further comprises a plurality of other components (not shown), such as a receiving module for receiving data from the communication network and other nodes, an output for sending the data to the communication network or other nodes, a processor and/or memory, for performing its usual tasks and procedures in communication systems, which are well known in the art and thus will not be described further.

The screen 100 can be used to view presence information, such as the geographical location of other end users, or to display any requested information.

The keyboard 102 allows an end user to enter requests to be transmitted to other nodes or users in the communication network.

The communication module 104 can be a SIP module, in the case where the terminal 18A is an IMS terminal used in the IMS network 10. The communication module 104 allows for communicating with other nodes in the IMS network 10. More specifically, the communication module 104 (or the SIP module) comprises a session module 106, a permission module 108 and an information module 110. It should be noted that the session module 106, the permission module 108 and the information module 110 can be a piece of software, a piece of hardware or a combination of both. Also, these modules can be viewed as functional parts of the same SIP module 104, meaning that the separation is only functional, a single module can be used to perform the different functions. In addition, they may be implemented in a same piece of hardware or in separate pieces.

The session module 106 allows for establishing a communication session with another end user, through the SIP INVITE request, for example, for communications in the IMS network 10. However, the SIP INVITE will have an indication that the communication session to be established will also include temporary sharing of personal information. The session module 106 also allows for terminating an established communication session.

The permission module 108 allows for determining or requesting for the permission to access the personal information concerning other end users. Indeed, the permission module 108 can send requests to change authorization policies of the personal information of the other end users in the case of IMS users. It can also receive updates on the permission access and authorization policies.

The information module 110 allows an end user to retrieve the personal information of other end users, during an established communication session, for example, once the permission access has been granted to that end user through the permission module 108.

The synchronization module 112 allows for synchronizing different times, such as a time defined for a communication session and a time defined for a subscription to presence information in IMS networks.

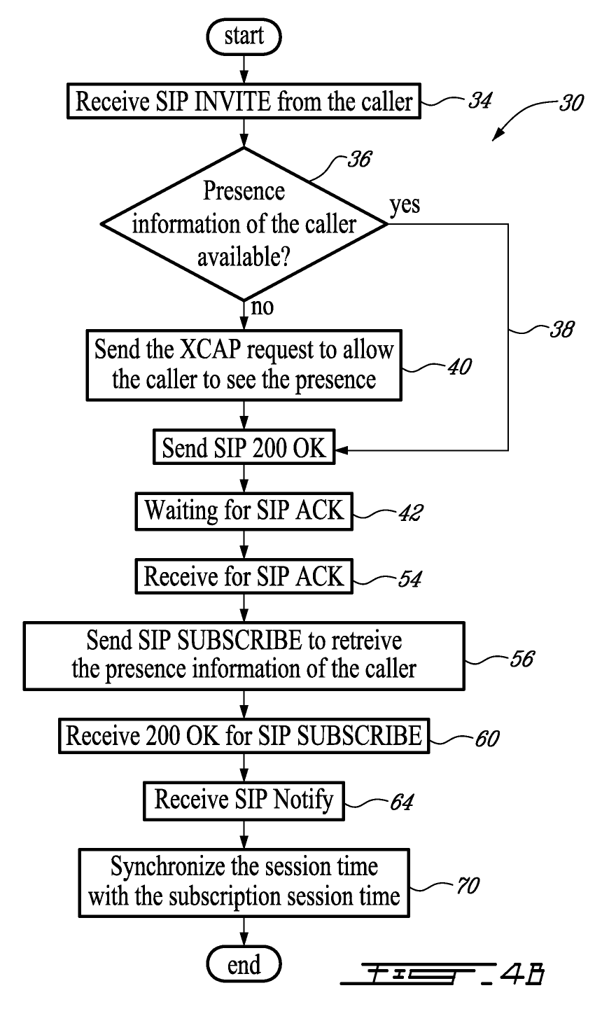

More specifically, FIG. 4 illustrates a detailed method for setting up a communication session or dialog during which personal information is shared temporarily between end user A and end user B, who are using a terminal such as 18A of FIG. 3. Furthermore, end users A and B have no prior or pre-defined authorization relationship between each other. Therefore, the method in FIG. 4 provides for a communication enhanced with temporary sharing of personal information.

In this method, end user A (the caller) is assumed to initiate the request for establishing the communication session with end user B (the callee).

Method 30 starts with step 32 where end user A (the caller) sends a SIP INVITE request to end user B (the callee) in order to establish a communication session between them. The SIP INVITE request includes an indication that the communication session being established will also allow for temporary sharing of personal information. As an example, the “Require” field of the SIP INVITE header can be used for providing the indication. The indication can be More specifically, to do so, first, end user A sends the SIP INVITE request, through the session module 106, to the S-CSCF 14A, which then forwards the SIP request to the S-CSCF 14B, to which end user B is connected. Also, before forwarding the SIP request, the S-CSCF 14A can apply some originating triggers to the SIP request, the originating triggers corresponding to the different services to which end user A is subscribed. The S-CSCF 14B then forwards the SIP request to end user B, after applying the terminating triggers to the SIP request.

In step 34, end user B receives the SIP INVITE, with the indication that the communication session being established is enhanced with temporary sharing of personal information, at his/her session module 106, from the caller (or end user A) via the S-CSCFs 14A and 14B.

In step 36, end user B determines if the personal information, such as the profile or presence information of end user A, is available to him or her, i.e. if end user B has any pre-existing or prior authorization relationships to access end user A's personal information. This is done through the permission module 108, for example.

If end user B has already authorization or permission to access the personal information of end user A, then in step 38, end user B sends a SIP 200 OK response to end user A and then will follow the standard procedure as specified in RFC 3261 and 3GPP IMS TS 24.229, as will be described hereinbelow.

However, in the case where in step 36 end user B does not have the authorization or permission to access the personal information of end user A, end user B sends a XCAP request, through the permission module 108, to PGM 16B in step 40, for giving end user A the permission to access or subscribe to end user B's personal information. The XCAP request is used to change the authorization policies of the personal information. For example, in the particular case of the presence information, end user B uses the XCAP request to update, i.e. change his/her presence information authorization policy in the PGM 16B so as to allow end user A to subscribe to his/her presence information. Then, end user B sends a SIP response (200 OK) to end user A, the SIP response passing through the S-CSCF 14B and S-CSCF 14A.

Next, end user B waits for a response from end user A, in step 42.

In step 44, end user A receives the SIP 200 OK sent by end user B in step 40.

In step 46, end user A determines if he/she has the personal information of end user B, i.e. end user A determines if he/she has any pre-existing or prior authorization relationships to access user B's personal information. This is done through the permission module 108, for example.

If end user A has authorization or permission to access the personal information of end user B, then end user A sends a SIP ACK to end user B, in step 48.

However, if end user A does not have permission to access this information, end user A then sends a XCAP request, through the permission module 108, in step 50 for allowing end user B to see, access or subscribe to end user A's personal information. For example, in the case of presence information, end user A changes his/her presence information authorization policy in the PGM 16A so as to allow end user B to subscribe to his/her presence information.

In step 52, end user A sends a SIP ACK to end user B through S-CSCF 14A and S-CSCF 14B to complete the communication session setup.

In step 54, end user B receives the SIP ACK sent by end user A at either step 48 or step 52, which completes the communication session setup.

In step 56, end user B sends a SIP SUBSCRIBE to S-CSCF 14B so as to retrieve the personal information of end user A, such as his/her presence information. This can be done through the information module 110 of the end user B's terminal 18B. S-CSCF 14B then forwards the SIP SUBSCRIBE to S-CSCF 14A, which in turn forwards it to PGM 16A.

In step 58, end user A sends a SIP SUBSCRIBE to S-CSCF 14A in order to subscribe to end user B's presence information and to be able to retrieve the presence information of end user B, for example. This can be done through the information module 110 of the end user A's terminal 18A. S-CSCF 14A then forwards the SIP SUBSCRIBE to S-CSCF 14B, which in turn forwards it to PGM 16B.

In step 60, end user B receives the SIP SUBSCRIBE response (200 OK) from end user A via S-CSCFs 14A and 14B, which acknowledges successful receipt of the SIP SUBSCRIBE request.

In step 62, end user A receives the SIP SUBSCRIBE OK response (200 OK) from end user B, via S-CSCFs 14B and 14A which acknowledges successful receipt of the SIP SUBSCRIBE request.

Since access permission has been given to end user B, end user B can access end user A's personal information. Therefore, in response to the SIP SUBSCRIBE request, end user B receives a SIP NOTIFY in step 64 which notifies end user B of the information retrieved or subscribed to.

In the same manner, end user A can access end user B's personal information and in response to the SIP SUBSCRIBE request, end user A receives a SIP NOTIFY, in step 66 which notifies end user A of the information retrieved or subscribed to.

Finally, as an optional step, in steps 68 and 70, respectively at the caller side (end user A) and the callee side (end user B), the session time can be synchronized with the subscription time through the synchronization module 112 of end users A and B's terminal 18A, for example.

It should be noted that when the communication session between end users A and B is terminated either by end user A or B or even both, the access permission to the personal information is also suspended.

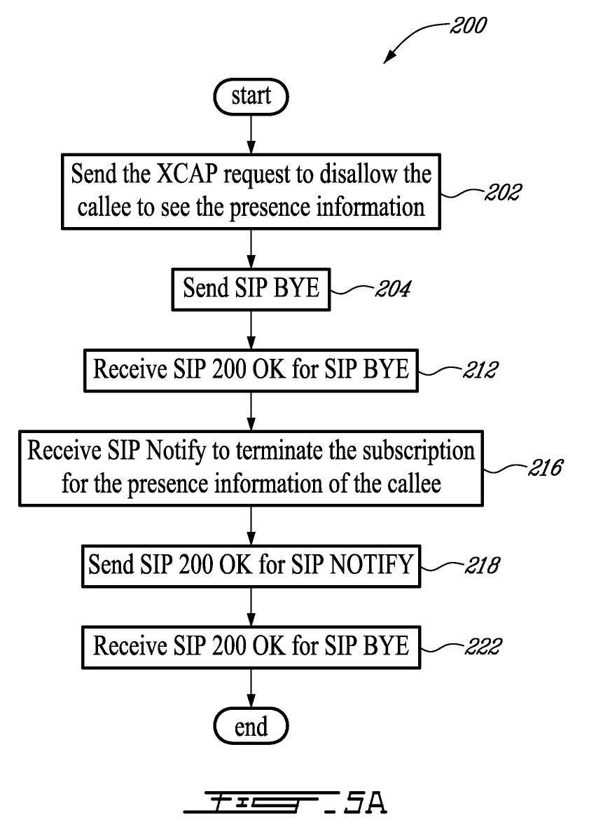

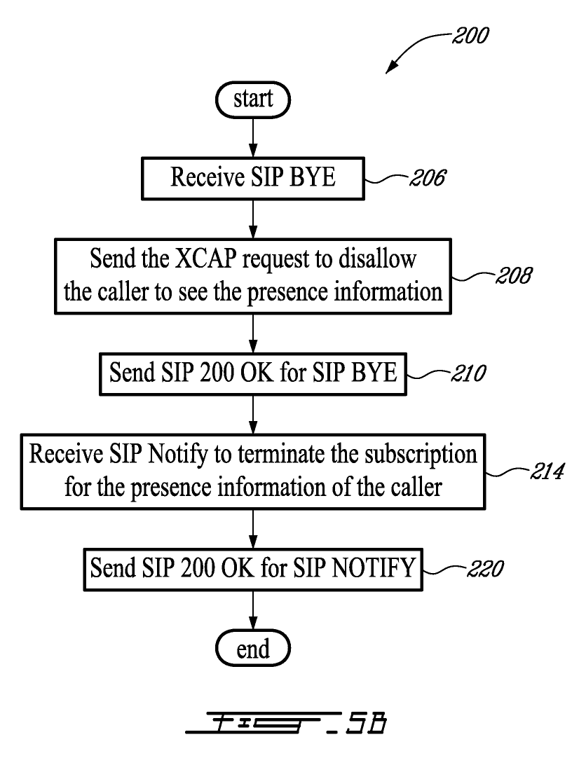

More specifically, FIG. 5 illustrates a flow chart or method for terminating the communication session established between end users A and B. End user A is still assumed to be the caller and end user B is the callee.

Method 200 for terminating the communication session as established in method 30, starts with step 202 where end user A informs its presence server PGM 16A to change the authorization policies so as to turn off the access permission for end user B to access his/her presence information. To do so, end user A sends a XCAP request to the PGM 16A to disallow end user B to see his/her presence information.

Then, in step 204 end user A sends out the SIP BYE towards end user B, so as to tear down the communication session.

In step 206, end user B receives the SIP BYE sent from end user A.

In step 208, after receiving the SIP BYE, end user B sends a XCAP request towards the PGM 16B to inform the latter to change the authorization policies so as to turn off the access permission for end user A to access his/her presence information.

In step 210, end user B sends a SIP 200 OK back to end user A upon successful receipt of SIP BYE.

In step 212, end user A receives the SIP 200 OK from end user B.

In step 214, end user B receives the notification from PGM 16B about the termination of his/her subscription to the presence information of end user A as a result of the XCAP request sent by end user A, i.e. end user B is notified by PGM 16B that end user A has removed the permission for end user B to access his/her presence information.

In step 216, end user A also receives the notification from PGM 16A about the termination of his/her subscription to the presence information of end user B as a result of the XCAP request sent by end user B, i.e. end user A is notified by PGM 16A that end user B has removed the permission for end user A to access his/her presence information.

In steps 218 and 220, end users A and B send out the SIP 200 OK to respectively PGM 16A and 16B upon successful receipt of the termination notification.

In step 222, end user A receives the SIP 200 OK sent by end user B for terminating the communication session.

It should be understood that the second node, which has been represented by end user B, can be also a service, such as a web-based service, offering IMS communication capabilities for a particular service. For example, the second node can be an online fashion store having a chat consultation service using IMS communication capabilities. When a user browses this online fashion store, he/she can initiate an IMS communication session with an online fashion consultant. During the consultation period, the online consultant can access the user's personal information, profile and location, for example, so as to enhance and personalize the consultation. Thus, the user can share his/her personal information without having to open any account with the online fashion store and the shared information lasts only for the duration of his/her visit to the online fashion store.

### Network's Side (Network-Based) Implementation

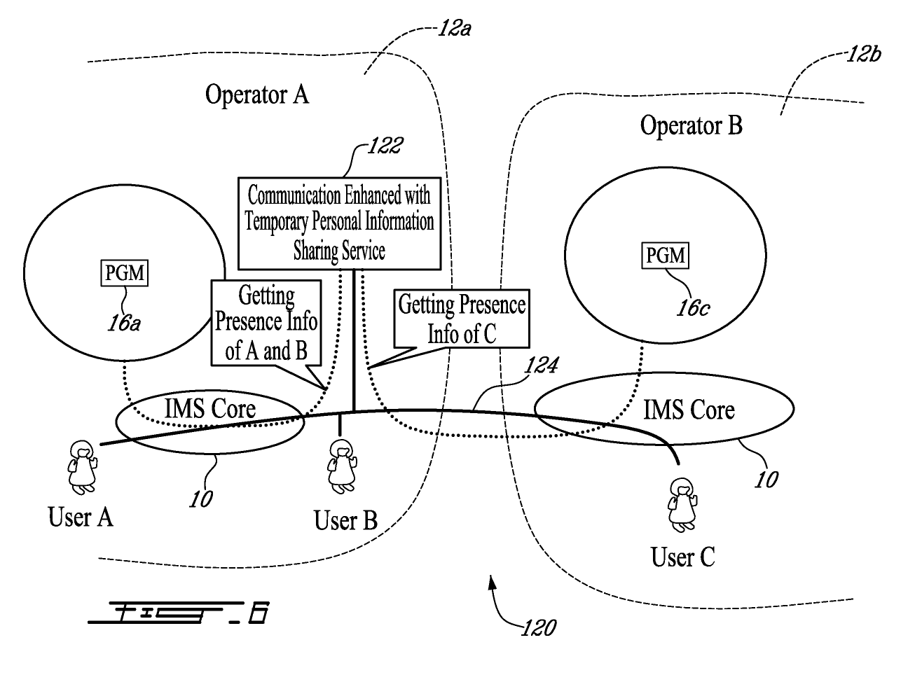

Now turning to FIG. 6, another non-restrictive illustrative embodiment, according to the present invention, in which method 20 is implemented in a communication network, will be described. In this illustrative embodiment, the communication network offers the service of setting up a communication session enhanced with sharing of personal information between end users who participate in the communication session.

FIG. 6 illustrates a communication network 120 based, for example, on the IMS technology, which comprises one or more IMS networks 10 and a communication enhanced with temporary personal information sharing service 122, provided by an application server, for example.

The IMS network 10 comprises different domains, such as domains 12A and 12B, to which end users are connected. For example, end user A and end user B are connected to domain 12A and end user C is connected to domain 12B. Also, the IMS network 10 comprises PGMs, such as 16A and 16C (only two PGMs are shown) for managing the presence information of end users A, B and C. Only end users A, B and C are shown in FIG. 6, however, a plurality of end users can be connected to the communication network 120.

The communication enhanced with temporary personal information sharing service 122 can be used for providing the service of temporary sharing of personal information between end users A, B and C while establishing and maintaining a communication session, as will be described hereinbelow. The service 122 can be found in the service layer of the IMS network 10, for example. Also, the service 122 can be identified by a Public Service Identity (PSI) in the IMS network 10.

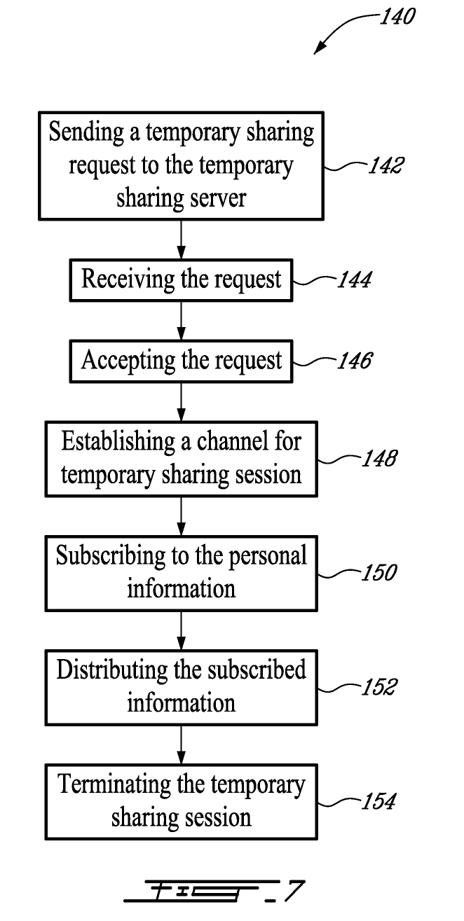

In FIG. 7, a detailed method 140 is illustrated for temporarily sharing personal information during a communication session between at least two nodes or more specifically in the following example between three nodes (end users A, B and C) using the infrastructure of the communication network 120 of FIG. 6. Furthermore, end users A, B and C have no prior or pre-defined authorization relationships between each other. Therefore, in the context of presence information, end users A, B and C cannot, initially, obtain each other's presence information. However, the communication enhanced with temporary personal information sharing service 122 can be pre-authorized to access the personal information of the end users connected to the communication network 120, such as end users A, B and C, or to receive individual authorizations thereof during the communication session.

For example, end user A wishes to set up a communication session with end users B and C. To do so, in step 142, end user A sends a request to the communication enhanced with temporary personal information sharing service 122, so that the service 122 can establish a communication session for end users A, B and C to share temporarily their personal information between each other. In the request sent by end user A, the following information is provided: 1) the kind of information that end user A wants to share during the communication session, e.g. presence information, profile information, etc. and 2) the end users that end user A wishes to invite. In further embodiments, additional information can be added in the request.

In step 144, the communication enhanced with temporary personal information sharing service 122 receives the request sent by end user A and starts inviting end users B and C to participate in a personal information sharing session with end user A. The invitation request to the sharing session comprises the following information: 1) an indication that the invitation is for a temporary sharing of personal information, 2) the kind of information that is to be shared during the communication session, e.g. presence information, profile information, etc. and 3) a list of end users with whom personal information can be shared during the communication session. In further embodiments, additional information can be added in the invitation request, such as a subset of preferences of information.

For example, assuming that the shared information is the presence information, the request to end user B would comprise: request end user B for temporary sharing session (with end users A and C, for presence information); end user C would receive a similar request by the communication enhanced with temporary personal information sharing service 122: request end user C for temporary sharing session (with end users A and B, for presence information).

In step 146, end users B and C receive the invitation requests from the communication enhanced with temporary personal information sharing service 122 and accept them. It should be noted that since from a particular end user's perspective, the request comes from the service 122, the particular end user needs only to allow the service 122 to access his/her personal information, i.e. the other end users do not have authorization/permission to access the personal information of that particular end user.

It should be noted that once the end users accept the invitation request, a conference session is created between them.

Then, in step 148, a channel 124 is established which is used for temporary sharing of personal information during the conference session as will be described hereinbelow. The channel 124 as illustrated connects end users A, B and C. The channel 124 thus established in the communication session is used for both communication and for distribution of agreed or retrieved personal information.

Once the end users have accepted the invitation request, the communication enhanced with temporary personal information sharing service 122 is granted permission by the end users during the session establishment to share their personal information, which is obtained by the service 122 from the PGM 16A, 16B and 16C, with the end users who participate in the communication session. For example, the service 122 can be pre-authorized to access the end users' personal information, which can be done using mechanisms that are well-known in the art. However, the service 122 still needs the permission from the end users to share their personal information with other end users.

Next, in step 150, the communication enhanced with temporary personal information sharing service 122 subscribes to the presence information of each of the end users A, B and C, in the case where the shared information is the presence information, using SIP SUBSCRIBE. Also, the service 122 receives notifications and updates of the presence information, through SIP NOTIFY.

The subscriptions are maintained during the conference session, or as long as the end users participate in the conference session.

In step 152, the communication enhanced with temporary personal information sharing service 122 then distributes the respective subscribed information to each end user A, B and C through the established channel 124.

It should be noted that any end user can terminate his/her participation in the temporary sharing session or conference session. However, it does not mean that the conference session is terminated when an end user leaves the session, as long as there are at least two remaining end users. For example, end user C decides to stop his/her conference session. To do so, he/she sends a request to the communication enhanced with temporary personal information sharing service 122 to leave the conference session. Upon reception of the request, the service 122 terminates the subscription to the presence information of that end user. However, the service 122 continues to receive notifications and updates of the presence information of the remaining end users (A and B) and to distribute them in the conference session. The conference session is not terminated for the remaining end users A and B.

In step 154, the temporary sharing session is terminated by the communication enhanced with temporary personal information sharing service 122. When the conference session is terminated, then the temporary sharing session is also terminated. For example, the termination of the conference session can be triggered when only one end user remains in the conference session. When the temporary sharing session is terminated, the sharing of personal information is also terminated.

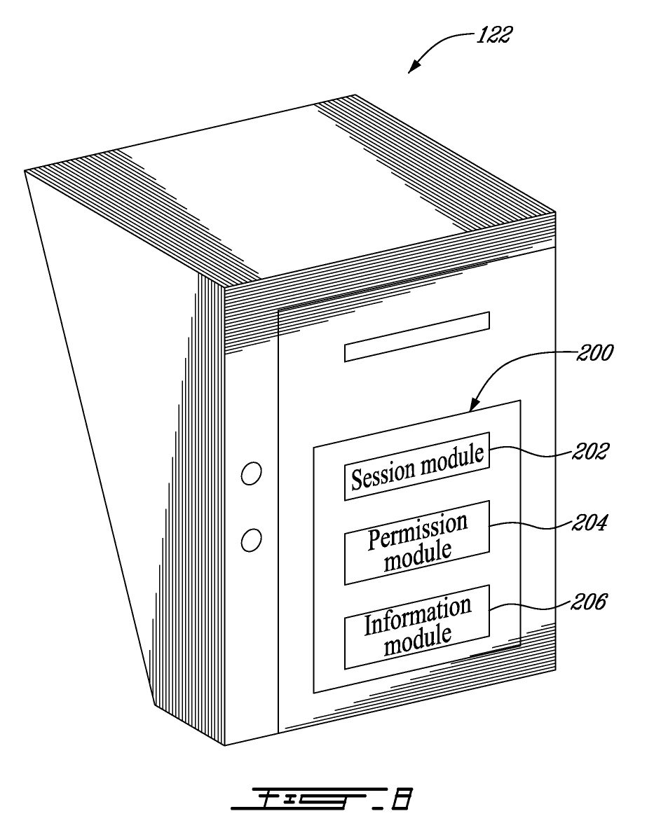

Now, turning to FIG. 8, a schematic illustration of the communication enhanced with temporary sharing service 122 is shown.

The communication enhanced with temporary personal information sharing service 122 comprises a communication module 200, similar to the communication 104 of FIG. 3. The communication module 200 can comprise a SIP module for IMS technologies, for example. The communication module 200 allows for communicating and sharing personal information with other nodes in the communication network 120.

More specifically, the communication module 200 comprises a session module 202, a permission module 204 and an information module 206. It should be noted that the session module 202, the permission module 204 and the information module 206 can be a piece of software, a piece of hardware or a combination of both. Also, these modules can be viewed as functional parts of the same communication module 200, meaning that the separation is only functional, a single module can be used to perform the different functions. In addition, they may be implemented in a same piece of hardware or in separate pieces.

The session module 202 allows for establishing an enhanced communication session, which may comprise temporary sharing of personal information between end users, upon receipt of a request from a particular end user. More specifically, the session module 202 allows for establishing a conference session between participating end users. The session module 202 also allows for terminating an established communication session.

The permission module 204 allows for receiving the permission to access the personal information of the end users and more specifically the information that an end user agrees to share with the other end users.

The information module 206 allows the service 122 to retrieve the personal information of the end users, during the established communication session, using SIP SUBSCRIBE for example and then to distribute the retrieved information to the end users using the established channel 124 of FIG. 6.

Of course, a person skilled in the art would understand that the communication enhanced with temporary personal information sharing service 122 further comprises a plurality of other components (not shown), such as an input/output module for receiving and sending data from and to the communication network 120 or other nodes, a processor and memory, in which instructions are stored, for performing its usual tasks and procedures in communication systems, which are well known in the art and thus will not be described further.

It should be noted that the terminal node 18 and the service 122 can be computers comprising at least a processor and memory in which instructions are stored for performing the functions described for the communication modules 104 and 200.

Although the present invention has been described in the foregoing specification by means of non-restrictive illustrative embodiments, these illustrative embodiments can be modified at will within the scope, spirit and nature of the subject invention.

1. A method for temporarily sharing personal information, in a communication network, between at least first and second nodes, the method comprising:
establishing a communication session between the at least first and second nodes;
receiving a permission to access the personal information; and
retrieving the personal information upon receiving the access permission;
wherein prior to establishment of the communication session, the at least first and second nodes have no authorization relationship established therebetween and when the established communication session is terminated, the access permission to the personal information is also terminated.

2. A method as defined in claim 1, further comprising determining if the personal information of the second node is available at the first node prior to receiving the permission to access the personal information.

3. A method as defined in claim 2, wherein determining if the personal information of the second node is available comprises:
sending a request for access permission if the personal information is unavailable.

4. A method as defined in claim 3, wherein sending the request for access permission comprises changing authorization policies of the personal information so as to allow access thereto and wherein receiving the permission to access the personal information comprises receiving the changed authorization policies.

5. A method as defined in claim 1, wherein the personal information comprises presence information.

6. A method as defined in claim 5, wherein retrieving the personal information comprises subscribing to the presence information.

7. A method as defined in claim 1, wherein temporary sharing of the personal information is done concurrently with the communication session establishment.

8. A method as defined in claim 4, further comprising changing the authorization policies of the personal information so as to turn off the access permission to the personal information, when the communication session is terminated.

9. A method as defined in claim 1, wherein establishing the communication session comprises establishing a conference session through a service for communication enhanced with temporary sharing of personal information.

10. A method as defined in claim 9, wherein establishing the conference session comprises sending an invitation request comprising information about a kind of conference session to establish, a kind of information to be shared and about end users to share the information.

11. A method as defined in claim 10, wherein the service receives the permission to share the personal information.

12. A method as defined in claim 11, wherein retrieving the personal information comprises:
subscribing to presence information by the service; and
distributing the subscribed presence information to the at least first and second nodes by the service.

13. A method as defined in claim 11, further comprising terminating the conference session for terminating the temporary sharing of personal information.

14. A method as defined in claim 13, wherein terminating the conference session is triggered by an event when only one end user remains in the conference session.

15. A node for temporarily sharing personal information, in a communication network, with at least another node, the node comprising:
a session module to establish a communication session with the at least another node;
a permission module to receive a permission of access to the personal information; and
an information module to retrieve the personal information during the established communication session;
wherein prior to establishment of the communication session, the node and the least another node have no authorization relationship established therebetween and when the established communication session is terminated, the access permission to the personal information is also terminated.

16. A node as defined in claim 15, wherein the at least another node comprises one of a user, a service and a web-based service.

17. A node as defined in claim 16, wherein the permission module determines if the personal information of the at least another node is available prior to receiving the permission to access the personal information.

18. A node as defined in claim 15, wherein the permission module requests changes of authorization policies of the personal information so as to allow access thereto and receives the changed authorization policies.

19. A node as defined in claim 15, wherein the personal information comprises presence information.

20. A node as defined in claim 19, wherein the information module retrieves the personal information by subscribing to the presence information.

21. A node as defined in claim 18, wherein the permission module changes the authorization policies of the personal information so as to turn off the access permission to the personal information, when the communication session is terminated.

22. A node as defined in claim 15, wherein the node comprises a service for communication enhanced with temporary sharing of personal information.

23. A node as defined in claim 22, wherein the service establishes a conference session upon receipt of a request from an end user, through the session module.

24. A node as defined in claim 23, wherein the service receives permission of sharing the personal information, through the permission module.

25. A node as defined in claim 24, wherein the personal information comprises presence information.

26. A node as defined in claim 25, wherein the service subscribes to the presence information and distributes the subscribed presence information to the least another node, upon receipt of the permission of sharing, through the information module.

27. A node as defined in claim 22, wherein the service terminates the conference session for terminating the temporary sharing of personal information, through the session module.

28. A node as defined in claim 27, wherein the service terminates the conference session in response to a trigger given by an event when only one end user remains in the conference session.
